(19) United States
(12) Patent Application Publication
(10) Pub. No.: US 2026/0231029 A1
(43) Pub. Date: Aug. 6, 2026

(54) METHOD AND DEVICE FOR MONITORING WAKE-UP SIGNAL, METHOD AND DEVICEFOR TRANSMITTING INFORMATION, AND COMPUTER STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/147,196

(22) PCT Filed: Jan. 13, 2023
(86) PCT No.: PCT/CN2023/072205

§ 371 Date: Jul. 10, 2025

(51) Int. Cl. H04W 52/02; H04W 68/02; H04W 72/20

(52) U.S. Cl. CPC H04W 52/0235; H04W 68/02; H04W 72/20

(57) ABSTRACT

A method for monitoring a wake-up signal, performed by a terminal, the method including: receiving first control information transmitted by a network device; determining a first duration according to the first control information; monitoring at least one wake-up signal during at least one monitoring occasion in the first duration; and determining, according to the at least one wake-up signal, whether to wake up a main radio, or whether to change a sleep state of the main radio.

### TECHNICAL FIELD

The present disclosure relates to the technical field of communication, and particularly relates to a method for monitoring a wake-up signal, a method for transmitting information, a device, and a computer storage medium.

### BACKGROUND OF THE INVENTION

In a wireless communication system, a wake-up signal (WUS) is introduced into the 3rd generation partnership project (3GPP) to reduce power of a terminal. The WUS is a type of low power detection signal. In a case where the WUS is detected by the terminal, a main radio may be activated by the terminal. In a case where no WUS is received or the WUS indicates no wake-up, the terminal can keep the main radio in a sleep state. Thus, the WUS plays an important role in a process of waking up the main radio. In view of that, how to better receive the wake-up signal is a technical problem demanding prompt solution.

### SUMMARY OF THE INVENTION

To solve problems in related art, the present disclosure provides a method for monitoring a wake-up signal, a method for transmitting information, a device, and a computer storage medium.

According to a first aspect of embodiments of the present disclosure, a method for monitoring a wake-up signal is provided. The method is performed by a terminal. The method includes:
receiving first control information transmitted by a network device;
determining first duration according to the first control information;
monitoring at least one wake-up signal at at least one monitoring occasion in the first duration; and
determining, according to the at least one wake-up signal, whether to wake up a main radio or whether to change a sleep state of the main radio.

According to a second aspect of embodiments of the present disclosure, a method for transmitting information is provided. The method is performed by a network device. The method includes:
transmitting first control information to a terminal, where the first control information is configured to determine first duration; and
transmitting at least one wake-up signal at at least one monitoring occasion in the first duration, where the wake-up signal is configured to wake up a main radio or to change a sleep state of the main radio.

According to a third aspect of embodiments of the present disclosure, a terminal is provided. The terminal includes:
a reception module configured to receive first control information transmitted by a network device; and
a processing module configured to determine first duration according to the first control information;
where the reception module is further configured to monitor at least one wake-up signal at at least one monitoring occasion in the first duration; and
the processing module is further configured to determine, according to the at least one wake-up signal, whether to wake up a main radio or whether to change a sleep state of the main radio.

According to a fourth aspect of embodiments of the present disclosure, a network device is provided. The network device includes:
a transmission module configured to transmit first control information to a terminal, where the first control information is configured to determine first duration;
where the transmission module is further configured to transmit at least one wake-up signal at at least one monitoring occasion in the first duration, where the wake-up signal is configured to wake up a main radio or to change a sleep state of the main radio.

According to a fifth aspect of embodiments of the present disclosure, a communication device is provided. The communication device includes:
a processor; and
a memory configured to store processor-executable instructions;
where the processor, when executing the processor-executable instructions, is configured to implement the method for monitoring a wake-up signal according to the first aspect of the present disclosure.

According to a sixth aspect of embodiments of the present disclosure, a communication device is provided. The communication device includes:
a processor; and
a memory configured to store processor-executable instructions;
where the processor, when executing the processor-executable instructions, is configured to implement the method for transmitting information according to the second aspect of the present disclosure.

According to a seventh aspect of embodiments of the present disclosure, a communication system is provided. The communication system includes:
a terminal, where the terminal performs the method for monitoring a wake-up signal according to the first aspect of the present disclosure; and
a network device, where the network device performs the method for transmitting information according to the second aspect of the present disclosure.

According to an eighth aspect of embodiments of the present disclosure, a computer-readable storage medium is provided. The computer-readable storage medium stores computer program instructions. The computer program instructions, when being executed by a processor, implement the method for monitoring a wake-up signal according to the first aspect or the method according to the second aspect of the present disclosure.

The technical solution provided by the embodiments of the present disclosure can have the following beneficial effects: the first duration is determined according to the first control information transmitted by the network device, and the at least one wake-up signal is monitored at the at least one monitoring occasion in the first duration, such that the wake-up signal can be positioned more accurately, and further power in a data transmission process can be reduced.

It is to be understood that the above general description and the following detailed description are merely illustrative and explanatory, instead of limiting the present disclosure.

### BRIEF DESCRIPTION OF DRAWINGS

The above and/or additional aspects and advantages of the present disclosure will become obvious and comprehensible from the description of embodiments in conjunction with the drawings.

FIG. 1 is a schematic diagram of a communication system according to an embodiment.

FIG. 2 is a schematic diagram of a first working mechanism for configuring a paging occasion according to an embodiment.

FIG. 3 is a schematic diagram of a second working mechanism for configuring a paging occasion according to an embodiment.

FIG. 4 is a schematic diagram of a third working mechanism for configuring a paging occasion according to an embodiment.

FIG. 5 is a flowchart of a method for monitoring a wake-up signal according to an embodiment.

FIG. 6 is a flowchart of a method for monitoring a wake-up signal according to another embodiment.

FIG. 7 is a flowchart of a method for monitoring a wake-up signal according to yet another embodiment.

FIG. 8 is a flowchart of a method for monitoring a wake-up signal according to yet another embodiment.

FIG. 9 is a flowchart of a method for monitoring a wake-up signal according to yet another embodiment.

FIG. 10 is a flowchart of a method for monitoring a wake-up signal according to yet another embodiment.

FIG. 11 is a flowchart of a method for monitoring a wake-up signal according to yet another embodiment.

FIG. 12 is a flowchart of a method for monitoring a wake-up signal according to still another embodiment.

FIG. 13 is a flowchart of a method for transmitting information according to an embodiment.

FIG. 14 is a flowchart of a method for transmitting information according to another embodiment.

FIG. 15 is a flowchart of a method for transmitting information according to yet another embodiment.

FIG. 16 is a block diagram of a terminal according to an embodiment.

FIG. 17 is a block diagram of a network device according to an embodiment.

FIG. 18 is a block diagram of a communication device according to an embodiment.

FIG. 19 is a block diagram of a communication device according to an embodiment.

### DETAILED DESCRIPTION OF THE INVENTION

Examples will be described in detail in the present disclosure and shown in the accompanying drawings illustratively. When the following description involves the accompanying drawings, unless otherwise specified, an identical number in different accompanying drawings denotes identical or similar elements. Implementations described in the following examples do not denote all implementations consistent with the present disclosure. On the contrary, the implementations are merely instances of a device and a method consistent with some aspects of the present disclosure as detailed in the appended claims.

It is to be noted that all actions of obtaining signals, information or data in the present disclosure are conducted under the premise of complying with corresponding data protection laws and policies of the current country and obtaining authorization from a corresponding device owner.

The terms such as “first” and “second” used in the description of the present disclosure are used for distinguishing between similar objects and are not necessarily understood to indicate a particular order or sequential order. In addition, in the description with reference to the drawings, the same reference numerals in different drawings denote identical elements unless otherwise stated.

In the description of the present disclosure, unless otherwise specified, “plurality” means two or more, and other quantifiers are similar to the description. “At least one,” “one or more” or similar expressions refer to any combination of the items, including a single item or any combination of plural items. For instance, “at least one” may represent any number. Further, for instance, one or more of a, b or c may be expressed as: a, b, c, a-b, a-c, b-c, or a-b-c, where a single one or more of a, b and c may exist. “And/or” indicates an association relationship that describes associated objects, and means that there may be three kinds of relationships. For instance, A and/or B may mean that A exists alone, A and B exist at the same time, and B exists alone, where A and B may be singular or plural.

Although operations or steps are described in a specific order in the drawings in the embodiments of the present disclosure, it is not to be understood that the operations or the steps are required to be executed in the specific order or serial order shown or all the operations or steps shown are required to be executed to obtain desired results. In the embodiments of the present disclosure, the operations or the steps may be performed in series. Alternatively, the operations or the steps may be performed in parallel. Alternatively, some of the operations or the steps may be performed.

Firstly, an implementation environment of the embodiments of the present disclosure will be introduced below.

Technical solutions of the embodiments of the present disclosure may be applied to various types of communication systems. The communication systems may include one or more of a 4th generation (4G) communication system, a 5th generation (5G) communication system, and other future wireless communication systems (such as a 6G). Alternatively, the communication systems may include a public land mobile network (PLMN), a device-to-device (D2D) communication system, a machine-to-machine (M2M) communication system, an internet of things (IoT) communication system, a vehicle-to-everything (V2X) communication system, or other communication systems.

FIG. 1 is a schematic diagram of a communication system according to an example. As shown in FIG. 1, the communication system may include a terminal 11 and a network device 12. The communication system may be configured to support a 4G network access technology (such as a long term evolution (LTE) access technology), a 5G network access technology (such as a new radio access technology (New RAT)), or other future wireless communication technologies. It is to be noted that in the communication system, both a number of network devices 12 and a number of terminals 11 may be one or more. The number of network devices 12 and the number of terminals 11 in the communication system shown in FIG. 1 are merely illustrative, which is not limited by the present disclosure.

The network device 12 in FIG. 1 may be configured to support access of the terminal 11. For instance, the network device 12 may be an evolutional node B (eNB or eNodeB) in LTE. Alternatively, the network device 12 may be a next generation node B (gNB or gNodeB) in a 5G network. Alternatively, the network device 12 may be a new generation-radio access network (NG-RAN) device in a 5G network. Alternatively, the network device 12 may be a base station, a broadband network gateway (BNG), a convergence switch, or a non-3rd generation partnership project (3GPP) access device in a future evolved public land mobile network (PLMN).

In an example, the network device 12 in the embodiments of the present disclosure may include various forms of base stations, such as a macro base station, a micro base station (or a small station), a relay station, an access point, a 5G base station or future base station, a satellite, a transmitting and receiving point (TRP), a transmitting point (TP), a mobile switching center and other devices serving as base stations in a device-to-device (D2D) communication, a machine-to-machine (M2M) communication, an Internet of Things (IoT) communication, a vehicle-to-everything (V2X) communication, or other communication, etc., which are not limited in the embodiments of the present disclosure. For convenience of description, in the embodiments of the present disclosure, devices providing a wireless communication function for the terminal 11 are collectively referred to as the network device 12 or the base station.

The terminal 11 in FIG. 1 may be an electronic device providing voice or data connectivity. For instance, the terminal 11 may be referred to as user equipment (UE), a subscriber unit, a mobile station, a station, a terminal device, etc. For instance, the terminal 11 may include a smart phone, a smart wearable device, a smart speaker, a smart tablet, a radio modem, a wireless local loop (WLL) station, a personal digital assistant (PDA), customer premise equipment (CPE), etc. With development of a wireless communication technology, devices that may access the communication system, may be in communication with the network device of the communication system, may be in communication with other objects through the communication system, or devices that may achieve direct communication between two or more devices may all be the terminal 11 in the embodiments of the present disclosure, such as terminals and cars in intelligent transportation, household devices in smart homes, power meter reading instruments in smart grids, voltage monitoring instruments, environmental monitoring instruments, video monitoring instruments in intelligent security networks, and cash registers. In the embodiments of the present disclosure, the terminal 11 may be in communication with the network device 12. A plurality of the terminals 11 may be in communication with each other. The terminal 11 may be static and immobile, or mobile, which is not limited by the present disclosure.

In an embodiment, the terminal 11 in FIG. 1 may be a terminal supporting a power saving function. The terminal may include a low-power (LP) wake-up receiver (WUR) and a main radio (MR). The wake-up receiver may be referred to as an LP-WUR. For instance, the main radio of the terminal 11 may be in a sleep state of different degrees in a case where there is no data transceiving by the terminal 11. In an implementation, the sleep state of the terminal 11 may include one or more of an ultra-deep sleep, a deep sleep, a light sleep, or a micro sleep. Time required for the main radio of the terminal 11 to wake up from different sleep states is different. In addition, due to different hardware or software capabilities of the terminal 11, time required for different terminals 11 to wake up from a same sleep state is different.

It is to be noted that the terminal 11 may be in a wake-up state after being woken up. The wake-up state of the terminal 11 may be considered as a different state relative to the sleep state, or as a special form of the sleep state, which is not limited by the present disclosure.

It is to be noted that the main radio may include at least one of a main transceiver or a main receiver. One or more main transceivers may be provided, and one or more main receivers may be provided.

The terminal 11 in FIG. 1 may support reception of a low-power wake-up signal (WUS).

In an embodiment, the terminal may receive the WUS through the main radio (at least one of the main transceiver or the main receiver).

In another embodiment, the terminal may use a separate receiver to receive the WUS, and use the main transceiver to receive downlink signal and transmit uplink signal, or use the main receiver to receive the downlink signal. At least one of the main receiver or the main transceiver may be referred to as the main radio of the terminal. In a case where the terminal receives a WUS instructing the terminal to wake up, the terminal activates the main transceiver to receive, transmit and process downlink/uplink information, or activates the main receiver to receive and process the downlink information. In a case where the WUS is not received or the WUS indicates no wake-up, the terminal keeps the sleep state of at least one of the main transceiver or the main receiver. The WUS may be applied to any state of the terminal, such as a radio resource control (RRC) connected state, an RRC idle state, or an RRC deactivated state.

In downlink beam management, for any one of a plurality of candidate transmitting beams, the terminal generally needs to use a plurality of corresponding candidate receiving beams for receiving measurement, so as to find an optimal transmitting-receiving beam pair. A number of the receiving beams and an implementation of the receiving beams are determined by the terminal, and the terminal may not transmit the number of the receiving beams to the base station after obtaining the number of the receiving beams. Further, the terminal may not transmit the optimal beam corresponding to the transmitting beam to the base station, but may directly store the optimal beam in the terminal.

In order to ensure a coverage radius of the low-power wake-up signal (LP WUS), the network device may use different beams to transmit the LP WUS in different time domain resources. Further, in order to ensure that the main radio woken by the LP WUS may work in time, a paging occasion (PO) needs to be configured at a proper position. In this process, there are three working mechanisms.

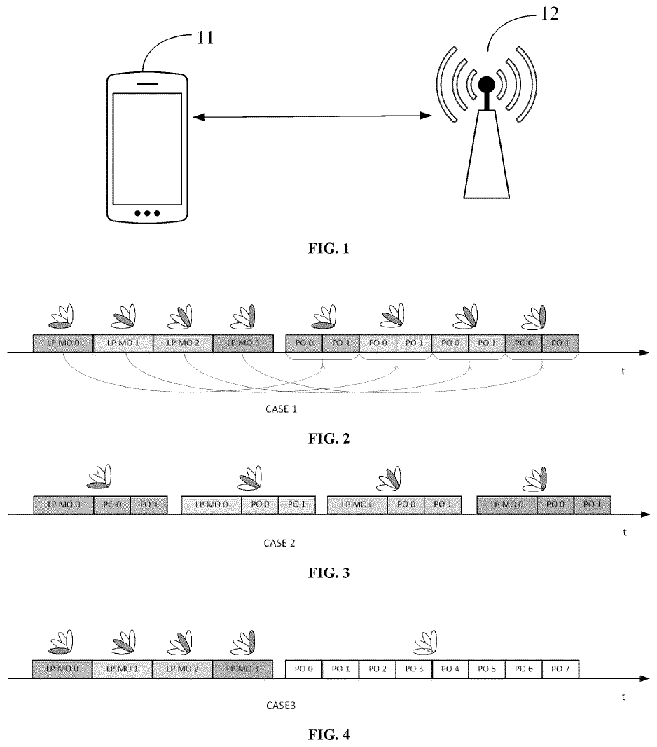

A first working mechanism is also referred to as Case1. In this mechanism, a plurality of low-power monitoring occasions (LP MOs) may be continuously configured, and the network device may use different transmitting beams for different LP MOs. Each receiving beam of the terminal may try to receive the low-power wake-up signal, and then the main radio may be woken up, and then the optimal transmitting beam may be selected. A relationship between the LP MO and the PO in the first working mechanism may be shown in FIG. 2.

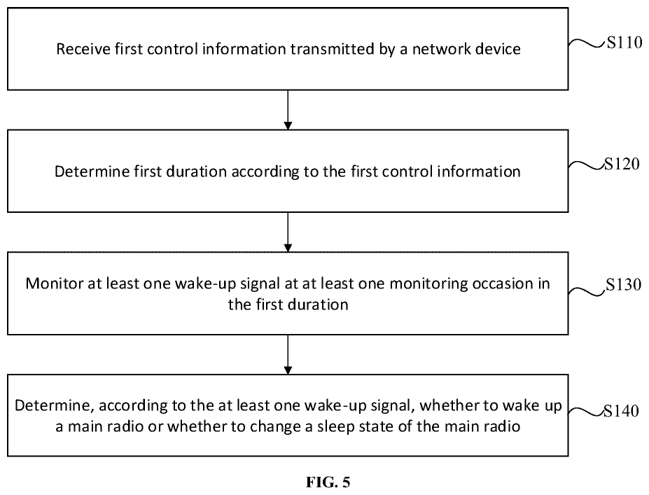

A second working mechanism is also referred to as Case2. In this mechanism, the low-power monitoring occasion and the paging occasion may be configured in a binding manner. That is, one low-power monitoring occasion may correspond to one or more paging occasions, or one paging occasion may correspond to one or more low-power monitoring occasions. Each group of LP MO+PO may correspond to one kind of beams. That is, beams for each group of low-power monitoring occasions and paging occasions may be identical, and the terminal may select a better beam. In other words, the terminal may wake up the main radio after receiving the beam. A relationship between the low-power monitoring occasion and the paging occasion in the second working mechanism may be shown in FIG. 3.

A third working mechanism is also referred to as Case3. In this mechanism, a plurality of low-power monitoring occasions may be continuously configured, and the network device may use different transmitting beams for different low-power monitoring occasions. In addition, the terminal may report at least one of the optimal beam or a sub-optimal beam to the network device before receiving the paging occasion, such that the terminal may transmit the paging occasion through at least one of the optimal beam or the sub-optimal beam. A relationship between the low-power monitoring occasion and the paging occasion in the third working mechanism may be shown in FIG. 4.

The terminal cannot locate the paging occasion well after LP WUS sweeping, and the terminal may not transmit at least one of the optimal beam or the sub-optimal beam to the network device, resulting in poor reception of the low-power wake-up signal.

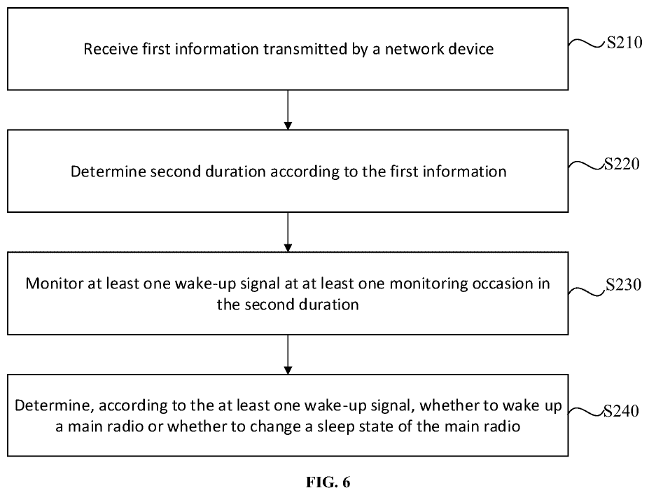

FIG. 5 is a flowchart of a method for monitoring a wake-up signal according to an embodiment. As shown in FIG. 5, the method may be performed by a terminal. The method includes steps S110, S120, S130 and S140.

Step S110 includes receiving first control information transmitted by a network device.

In some implementations, the terminal may receive the first control information transmitted by the network device. The first control information may be configured to determine first duration. The first control information may be carried by signaling such as RRC, downlink control information (DCI), and a media access control control element (MAC CE).

Step S120 includes determining the first duration according to the first control information.

In an embodiment of the present disclosure, the first duration may include at least one of second duration or third duration. The second duration may be related to a LP WUS frame (LPF). The third duration may be related to a LP WUS monitoring occasion (LP MO).

In some implementations, the first control information may directly include the first duration, and accordingly, the terminal may directly use the first control information as the first duration. In an example, the terminal may compute and obtain the first duration according to information included in the first control information.

Step S130 includes monitoring at least one wake-up signal at at least one monitoring occasion in the first duration.

In some implementations, after obtaining the first duration, the terminal may monitor the at least one wake-up signal at the at least one monitoring occasion in the first duration. Based on this, the terminal may determine, based on the monitored wake-up signal, at least one of the following information: a total number of wake-up signals in the first duration; or a number of current wake-up signals in the first duration.

In other words, each wake-up signal monitored by the terminal in the first duration may carry the total number of all wake-up signals in the first duration. In an example, each wake-up signal may carry the number of the current wake-up signals in the first duration. In an example, each wake-up signal may carry the total number of wake-up signals in the first duration and the number of the current wake-up signals in the first duration.

It is to be noted that in a case where the first duration is different, corresponding information determined by the terminal may be different. For instance, the terminal may determine a total number of wake-up signals in second duration. For instance, the terminal may determine a total number of wake-up signals in third duration.

In addition, the terminal may determine a last wake-up signal in the first duration according to a signal label. That is, the last wake-up signal in the first duration may include the signal label. The signal label is configured to indicate whether the wake-up signal carrying the signal label is the last wake-up signal in the first duration.

In an implementation, the last wake-up signal in the first duration may be a low-power wake-up signal (LP WUS). That is, the last wake-up signal in the first duration may carry the signal label. The terminal may determine a last low-power wake-up signal in the first duration according to the signal label. In a case where the first duration is different, the corresponding last wake-up signals may include different signal labels.

Step S140 includes determining, according to the at least one wake-up signal, whether to wake up a main radio or whether to change a sleep state of the main radio.

In an embodiment of the present disclosure, the terminal may include the main radio and a wake-up receiver (WUR). The terminal may use the wake-up receiver to monitor and receive the at least one wake-up signal configured to wake up the main radio in a sleep state. In a case where the at least one wake-up signal received by the wake-up receiver is used for waking up an associated main radio, the wake-up receiver may wake up the main radio through an internal association mechanism.

In an example, the terminal may use the wake-up receiver to monitor and receive the wake-up signal configured to change the sleep state of the main radio. In a case where the wake-up signal received by the wake-up receiver is used for changing the sleep state of the associated main radio, the wake-up receiver may change the sleep state of the main radio through an internal association mechanism.

The sleep states of the main radio may include an ultra-deep sleep state, a deep sleep state, a light sleep state, and a micro sleep state.

As an instance, after the terminal receives a first wake-up signal, the terminal may be woken up, that is, may be switched from the sleep state to a wake-up state. As another instance, after the terminal receives a second wake-up signal, the sleep state of the terminal may be switched from the deep sleep state to the micro sleep state.

It is to be noted that the at least one wake-up signal in the embodiment of the present disclosure may be a low-power wake-up signal (LP WUS).

According to the embodiments of the present disclosure, the first duration is determined according to the first control information transmitted by the network device, and the at least one wake-up signal is monitored at the at least one monitoring occasion in the first duration, such that the wake-up signal can be positioned more accurately, and further power in a data transmission process can be reduced.

FIG. 6 is a flowchart of a method for monitoring a wake-up signal according to another embodiment. As shown in FIG. 6, the method may be performed by the terminal. The method includes steps S210, S220, S230, and S240.

Step S210 includes receiving first information transmitted by a network device.

In an embodiment of the present disclosure, the first information may include at least one of a time length of a LP WUS frame, a number of the LP WUS frames in an entire wake-up signal period, a start radio frame of the LP WUS frame, an end radio frame of the LP WUS frame, an identification (ID number) of the terminal, a density of the LP WUS frames, an offset of the LP WUS frame, or a system frame number of the LP WUS frame.

Step S220 includes determining second duration according to the first information.

In an example, after receiving the first information transmitted by the network device, the terminal may determine the second duration based on the first information. The second duration is related to the LP WUS frame, and accordingly, the embodiment of the present disclosure may determine the second duration according to the first information related to the LP WUS frame.

In an implementation, the first information may include a LP WUS frame indication field. The LP WUS frame indication field is configured to indicate the LP WUS frame to the terminal. The LP WUS frame indication field may include any one of the following: a time length of the LP WUS frame, a number of the LP WUS frames in an entire LP WUS period, a start radio frame of the LP WUS frame, an end radio frame of the LP WUS frame, an identification (ID number) of the terminal, a density of the LP WUS frames, an offset of the LP WUS frame, etc. The LP WUS frame indication field may be carried by RRC, DCI, MAC CE and other signaling. In another embodiment, the first information may include a first parameter. The first parameter may include the offset of the LP WUS frame and the number of the LP WUS frames in the entire LP WUS period. The first parameter may be notified to the terminal by the network device through the RRC, the DCI, the MAC CE and other signaling.

The number of the LP WUS frames in the entire LP WUS period may refer to the low-power wake-up signal (LP WUS) period. In addition, after receiving the first parameter, the terminal may compute and obtain a system frame number of the LP WUS frame based on the first parameter.

As an instance, the system frame number of the LP WUS frame L=(SFN+P_offset) mod T. SFN may denote the system frame number. P_offset denotes the offset of the LP WUS frame, mod denotes a modulo operation, and T denotes the LP WUS period, that is, a number of system frames in the LP WUS period.

It is to be noted that the first parameter may be received by the terminal from the network device or may be a system default value. The system default value may be predefined by a protocol.

Step S230 includes monitoring at least one wake-up signal at at least one monitoring occasion in the second duration.

In an example, after obtaining the second duration, the embodiment of the present disclosure may monitor the at least one wake-up signal at the at least one monitoring occasion in the second duration. In other words, the terminal may monitor the at least one wake-up signal at the at least one monitoring occasion in the determined LP WUS frame.

In addition, the terminal may determine a total number of wake-up signals in the second duration according to the monitored wake-up signal and/or determine a number of current wake-up signals in the second duration. That is, the wake-up signal may include a total number of low-power wake-up signals (LP WUSs) in the second duration and a number of current LP WUSs in the second duration. According to the total number of the LP WUSs and the number of the current LP WUSs in the second duration, the terminal may locate the wake-up signals in the second duration. In other words, the LP WUSs may be counted through the total number T1 of the LP WUSs and the number C1 of the current LP WUSs in the second duration.

In an example, the terminal may determine a last wake-up signal in the second duration according to a signal label. That is, the last wake-up signal in the second duration may include the signal label. The signal label is configured to indicate whether the wake-up signal carrying the signal label is the last wake-up signal in the first duration. The signal label of the last wake-up signal in the second duration is located, such that the embodiment of the present disclosure may locate the wake-up signals in the second duration.

Step S240 includes determining, according to the at least one wake-up signal, whether to wake up a main radio or whether to change a sleep state of the main radio.

Implementations of step S240 are described in detail in the above-mentioned embodiments of the present disclosure, and will not be repeated here.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, the second duration is determined according to the first information transmitted by the network device, and the at least one wake-up signal is monitored at the at least one monitoring occasion in the second duration, such that the wake-up signal can be positioned more accurately, and further power in a data transmission process can be reduced.

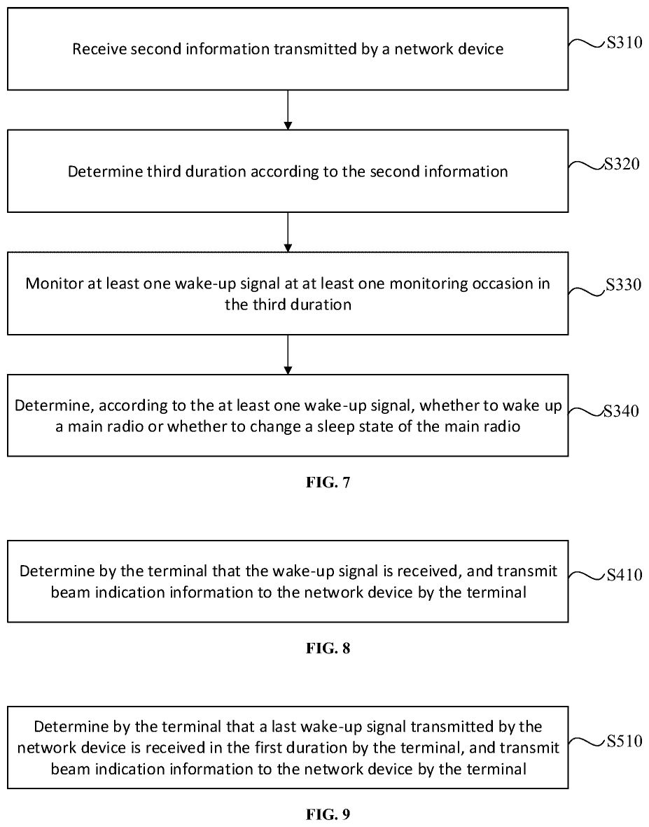

FIG. 7 is a flowchart of a method for monitoring a wake-up signal according to yet another embodiment. As shown in FIG. 7, the method may be performed by the terminal. The method includes steps S310, S320, S330, and S340.

Step S310 includes receiving second information transmitted by a network device.

In the embodiment of the present disclosure, the second information may include at least one of a time length of a low-power monitoring occasion, a number of the low-power monitoring occasions in an entire wake-up signal period, a start symbol of the low-power monitoring occasion, an end symbol of the low-power monitoring occasion, an identification of the terminal, a number of LP WUS frames in the entire wake-up signal period, a number of the low-power monitoring occasions in the LP WUS frame, a density of the low-power monitoring occasions, or an index of the low-power monitoring occasion.

Step S320 includes determining third duration according to the first control information.

In some implementations, after receiving the second information transmitted by the network device, the terminal may determine the third duration based on the second information. The third duration is related to the low-power monitoring occasion, and accordingly, the embodiment of the present disclosure may determine the third duration according to the second information related to the low-power monitoring occasion.

In an implementation, the second information may include a low-power monitoring occasion indication field. The low-power monitoring occasion indication field is configured to indicate the low-power monitoring occasion to the terminal. The low-power monitoring occasion indication field may include any one of the following: a time length of the low-power monitoring occasion, a number of the low-power monitoring occasions in an entire wake-up signal period, a start symbol of the low-power monitoring occasion, an end symbol of the low-power monitoring occasion, or a density of the low-power monitoring occasions. The low-power monitoring occasion indication field may be carried by RRC, DCI, MAC CE and other signaling.

In another embodiment, the second information may include a second parameter. The second parameter may include the number of the low-power monitoring occasions in the entire wake-up signal period, the number of the LP WUS frames in the entire wake-up signal period, the number of the low-power monitoring occasions in the LP WUS frame, or the identification of the terminal. The second parameter may be notified to the terminal by the network device through the RRC, the DCI, the MAC CE and other signaling.

In addition, after receiving the second parameter, the terminal may compute and obtain the index of the low-power monitoring occasion based on the second parameter.

As an instance, the index B of the low-power monitoring occasion satisfies B=floor(UE_ID/N) mod Ns. UE_ID may denote an ID number of the terminal, that is, the identification of the terminal. N may denote the number of the LP WUS frames included in the LP WUS period. Ns may denote the number of the low-power monitoring occasions in the LP WUS frame.

Step S330 includes monitoring at least one wake-up signal at at least one monitoring occasion in the third duration.

In an example, after obtaining the third duration, the embodiment of the present disclosure may monitor the at least one wake-up signal at the at least one monitoring occasion in the third duration. In other words, the terminal may monitor the at least one wake-up signal at the determined low-power monitoring occasion.

In addition, the terminal may determine a total number of the wake-up signals in the third duration according to the monitored wake-up signal and/or determine a number of current wake-up signals in the third duration. That is, the wake-up signal may include a total number of the LP WUSs in the third duration and a number of current LP WUSs in the third duration. According to the total number of the LP WUSs and the number of the current LP WUSs in the third duration, the terminal may locate the wake-up signal in the third duration. In other words, the LP WUS may be counted through the total number T2 of the LP WUSs and the number C2 of the current LP WUSs in the third duration.

In an example, the terminal may determine a last wake-up signal in the third duration according to a signal label. That is, the last wake-up signal in the third duration may include the signal label. The signal label is configured to indicate whether the wake-up signal carrying the signal label is the last wake-up signal in the first duration. The signal label of the last wake-up signal in the third duration is located, such that the embodiment of the present disclosure may locate the wake-up signal in the third duration.

Step S340 includes determining, according to the at least one wake-up signal, whether to wake up a main radio or whether to change a sleep state of the main radio.

Implementations of step S340 are described in detail in the above-mentioned embodiments, and will not be repeated here.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, the third duration is determined according to the second information transmitted by the network device, and the at least one wake-up signal is monitored at the at least one monitoring occasion in the third duration, such that the wake-up signal can be positioned more accurately, and further power in a data transmission process can be reduced.

FIG. 8 is a flowchart of a method for monitoring a wake-up signal according to yet another embodiment. As shown in FIG. 8, the method may be performed by the terminal. The method includes a step S410.

Step S410 includes determining by the terminal that a wake-up signal is received by the terminal, and transmitting beam indication information to a network device by the terminal. In an example, the terminal may transmit the beam indication information to the network device in a case of determining that the wake-up signal is received. That is, the terminal may transmit the beam indication information to the network device in a case where at least one wake-up signal is received. The beam indication information may be configured to indicate at least one of an optimal beam or a sub-optimal beam.

In a case of determining that the wake-up signal is received, the terminal may obtain a plurality of transmitting beams, and then select a plurality of target beams from the plurality of transmitting beams according to an energy of each transmitting beam. The plurality of target beams may be at least one of the optimal beams or the sub-optimal beams. In addition, the terminal may determine the optimal beam and the sub-optimal beam according to the energy received by the beam, or may determine the optimal beam and the sub-optimal beam through optimal pairing with receiving beams. Further, except for the optimal beam, other secondary optimal beams may be referred to as sub-optimal beams, other tertiary optimal beams may be referred to as sub-optimal beams, and other fourth optimal beams may also be referred to as optimal beams.

In an implementation, the beam indication information may indicate at least one piece of transmitting beam information through a beam pair. In the beam pair, one transmitting beam may correspond to one receiving beam. For instance, in a case where the transmitting beams include beam 0, beam 1, and beam 2 and the receiving beams include beam 3, beam 4, and beam 5, the beam pairs indicated by the beam indication information may be beam 0, beam 5; beam 1, beam 4; and beam 2, beam 3.

In another implementation, the beam indication information may indicate at least one piece of transmitting beam information through a beam index. For instance, in a case where the transmitting beams include beam 0, beam 1, and beam 2, the beam pairs indicated by the beam indication information may be beam 0; beam 1; and beam 2.

In an example, the beam indication information may indicate at least one piece of transmitting beam information through an index of the transmitting beam. A transmission form of the beam indication information is not explicitly limited in the present disclosure, as long as the beam indication information may clarify the transmitting beams included.

In an embodiment of the present disclosure, the beam indication information may be carried by a physical uplink shared channel (PUSCH) or uplink control information (UCI).

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, the terminal may transmit the beam indication information to the network device after determining that the wake-up signal is received. The beam indication information is configured to indicate information of at least one transmitting beam. The at least one transmitting beam may include at least one of the optimal beam or the sub-optimal beam. In this way, subsequent uplink and downlink transmission can be ensured.

FIG. 9 is a flowchart of a method for monitoring a wake-up signal according to yet another embodiment. As shown in FIG. 9, the method may be performed by the terminal. The method includes a step S510.

Step S510 includes determining by the terminal that a last wake-up signal transmitted by the network device is received in the first duration by the terminal, and transmitting beam indication information to the network device by the terminal.

In an example, in a case where it is determined that the last wake-up signal transmitted by the network device is received in the first duration, the terminal may transmit the beam indication information to the network device. The beam indication information may be configured to indicate at least one of the optimal beam or the sub-optimal beam. In the embodiment of the present disclosure, the beam indication information may be carried by a PUSCH or UCI.

The first duration may include the second duration and the third duration. Thus, in a case where the last wake-up signal transmitted by the network device is received in the second duration, the terminal may transmit the beam indication information to the network device. In another example, in a case where the last wake-up signal transmitted by the network device is received in the third duration, the terminal may transmit the beam indication information to the network device.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, the terminal may transmit the beam indication information to the network device in a case where the last wake-up signal transmitted by the network device is received in the first duration. The beam indication information is configured to indicate information of at least one transmitting beam. The at least one transmitting beam may include at least one of the optimal beam or the sub-optimal beam. Thus, subsequent uplink and downlink transmission can be further ensured.

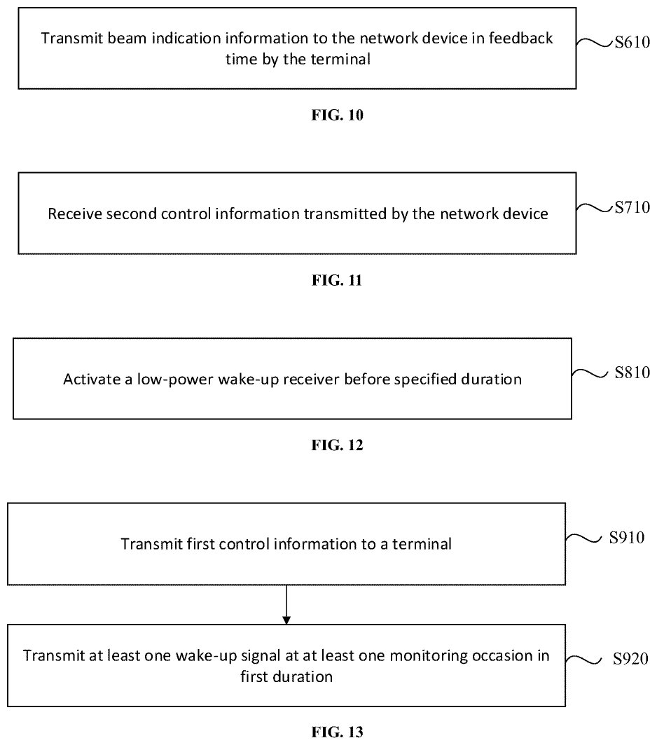

FIG. 10 is a flowchart of a method for monitoring a wake-up signal according to yet another embodiment. As shown in FIG. 10, the method may be performed by the terminal. The method includes a step S610.

Step S610 includes transmitting beam indication information to the network device in feedback time by the terminal.

In an example, the terminal may transmit the beam indication information to the network device in the feedback time. After receiving the LP WUS, the terminal may transmit the beam indication information to the network device in the feedback time.

In an implementation, after determining that the wake-up signal is received, the terminal may transmit the beam indication information to the network device in the feedback time.

In an example, after the terminal determines that the last wake-up signal transmitted by the network device is received in the first duration, the terminal may transmit the beam indication information to the network device in the feedback time.

In some implementations, the terminal may transmit the feedback time to the network device, so as to facilitate subsequent communication with the network device.

In an embodiment of the present disclosure, the feedback time may be predefined by a protocol or may be configured for the terminal by the network device. For instance, the feedback time may be at least one time domain symbol, for example, 2, 4, 5.5, 7, or 14 time domain symbols. Further, for instance, the feedback time may be at least one slot, for example, 1 or 2 slots. Further, for instance, the feedback time may be 100 microseconds, 0.5 millisecond, 1 millisecond, or other absolute time.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, after receiving the wake-up signal, the terminal may transmit the beam indication information to the terminal in the feedback time. Thus, accuracy of data transmission can be ensured.

FIG. 11 is a flowchart of a method for monitoring a wake-up signal according to yet another embodiment. As shown in FIG. 11, the method may be performed by the terminal. The method includes a step S710.

Step S710 includes receiving second control information transmitted by the network device. In some implementations, the terminal may receive the second control information transmitted by the network device. The second control information includes at least one of a correspondence between the monitoring occasion and a paging occasion, or a correspondence between the wake-up signal and the paging occasion.

In an example, in the second control information, at least one LP MO may correspond to at least one paging occasion. In an example, at least one LP WUS may correspond to at least one paging occasion.

In the embodiment of the present disclosure, the correspondence between the monitoring occasion and the paging occasion may be configured for the terminal by the network device through the second control information, or may be predefined by a protocol. The correspondence between the wake-up signal and the paging occasion may be configured for the terminal by the network device through the second control information, or may be predefined by a protocol.

In addition, a transmitting beam corresponding to the monitoring occasion is identical to a transmitting beam corresponding to the paging occasion. Alternatively, a transmitting beam corresponding to the wake-up signal is identical to a transmitting beam corresponding to the paging occasion. In other words, the terminal expects that the LP MO and the paging occasion for the corresponding WUS use identical transmitting beams on the network device. Similarly, the terminal expects that the corresponding LP WUS and the paging occasion use identical transmitting beams on the network device.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, the terminal may receive the second control information transmitted by the network device. The second control information may include at least one of the correspondence between the monitoring occasion and the paging occasion, or the correspondence between the wake-up signal and the paging occasion. Thus, the main radio of the terminal can be woken up faster.

FIG. 12 is a flowchart of a method for monitoring a wake-up signal according to still another embodiment. As shown in FIG. 12, the method may be performed by the terminal. The method includes a step S810.

Step S810 includes activating a low-power wake-up receiver before specified duration.

In an embodiment of the present disclosure, the terminal may activate the low-power wake-up receiver (LP WUR) in advance before the specified duration. The specified duration may be predefined by a protocol.

In an example, the specified duration may be determined by the network device. That is, the terminal may transmit a duration determination parameter to the network device and instruct the network device to obtain the specified duration based on the duration determination parameter. Based on this, the terminal may receive the specified duration transmitted by the network device, and activate the LP WUR in advance before the specified duration.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to monitor the wake-up signal, which will not be repeated here.

In addition, the wake-up signal in the embodiment of the present disclosure may be a low-power wake-up signal, that is, LP WUS.

According to the embodiments of the present disclosure, the terminal activates the low-power wake-up receiver in advance before the specified duration. That is, the low-power wake-up receiver is deactivated before receiving the wake-up signal and is activated before the specified duration. Thus, unnecessary power caused by signal monitoring can be reduced.

FIG. 13 is a flowchart of a method for transmitting information according to an embodiment. As shown in FIG. 13, the method may be performed by a network device. The method includes steps S910 and S920.

Step S910 includes transmitting first control information to a terminal.

In an embodiment of the present disclosure, the first control information is configured to determine first duration. The first duration may include at least one of second duration or third duration. The second duration is related to a LP WUS frame. The third duration is related to a low-power monitoring occasion.

In some implementations, the first control information may include first information. The first information is configured to determine the second duration. The first information may include at least one of a time length of the LP WUS frame, a number of the LP WUS frames in an entire wake-up signal period, a start radio frame of the LP WUS frame, an end radio frame of the LP WUS frame, an identification of the terminal, a density of the LP WUS frames, an offset of the LP WUS frame, or a system frame number of the LP WUS frame.

In some other implementations, the first control information may further include second information. The second information is configured to determine the third duration. The second information includes at least one of a time length of the low-power monitoring occasion, a number of the low-power monitoring occasions in an entire wake-up signal period, a start symbol of the low-power monitoring occasion, an end symbol of the low-power monitoring occasion, an identification of the terminal, a number of LP WUS frames in the entire wake-up signal period, a number of the low-power monitoring occasions in the LP WUS frame, a density of the low-power monitoring occasions, or an index of the low-power monitoring occasion.

Step S920 includes transmitting at least one wake-up signal at at least one monitoring occasion in the first duration.

In some implementations, the network device may transmit the at least one wake-up signal at the at least one monitoring occasion in the first duration. The wake-up signal is configured to wake up a main radio or to change a sleep state of the main radio. In addition, the wake-up signal may carry any one of the following information: a total number of wake-up signals in the first duration; or a number of current wake-up signals in the first duration.

In addition, the at least one wake-up signal includes a last wake-up signal in the first duration. The last wake-up signal includes a signal label. The signal label is configured to indicate whether the wake-up signal carrying the signal label is the last wake-up signal in the first duration.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to transmit information, which will not be repeated here.

In addition, the wake-up signal in the embodiment of the present disclosure may be a low-power wake-up signal, that is, LP WUS.

In the embodiment of the present disclosure, the network device may transmit the first control information to the terminal. The first control information is configured to determine the first duration. The network device may instruct, through the first control information, the terminal to determine the first duration, and the at least one wake-up signal may be monitored at the at least one monitoring occasion in the first duration. Thus, the wake-up signal can be positioned more accurately, and further power in a data transmission process can be reduced.

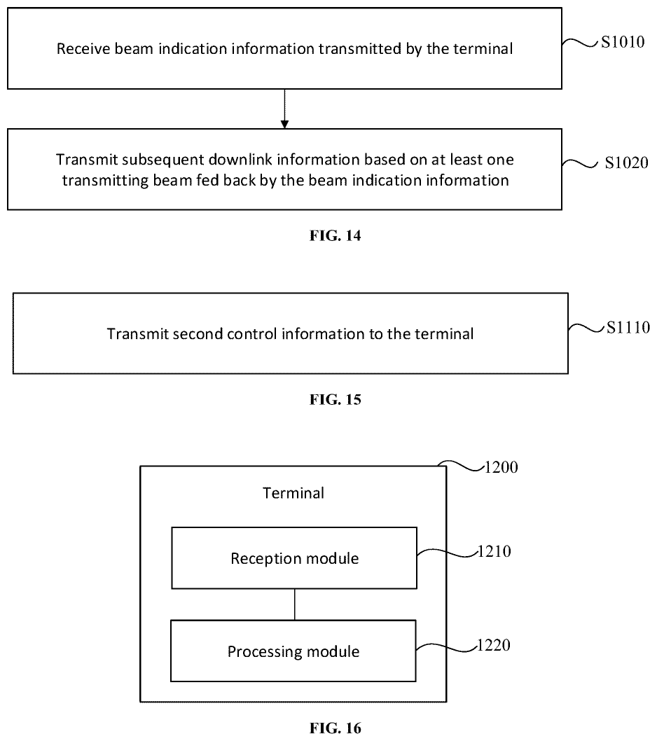

FIG. 14 is a flowchart of a method for transmitting information according to another embodiment. As shown in FIG. 14, the method may be performed by the network device. The method includes steps S1010 and S1020.

Step S1010 includes receiving beam indication information transmitted by the terminal.

In an embodiment of the present disclosure, the beam indication information may be configured to indicate at least one of an optimal beam or a sub-optimal beam.

The beam indication information may be transmitted to the network device by the terminal in a case where the terminal determines that the wake-up signal is received. The beam indication information may be transmitted to the network device by the terminal in a case where the terminal receives the last wake-up signal transmitted by the network device in the first duration. In an example, the beam indication information may be transmitted to the network device by the terminal in feedback time. The feedback time may be predefined by a protocol or may be configured for the terminal by the network device. For instance, the feedback time may be at least one time domain symbol, for example, 2, 4, 5.5, 7, or 14 time domain symbols. Further, for instance, the feedback time may be at least one slot, for example, 1 or 2 slots. Further, for instance, the feedback time may be 100 microseconds, 0.5 millisecond, 1 millisecond, or other absolute time.

Step S1020 includes transmitting subsequent downlink information based on at least one transmitting beam fed back by the beam indication information.

In some implementations, after receiving the beam indication information, the terminal may transmit the subsequent downlink information according to the at least one transmitting beam fed back by the beam indication information.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to transmit information, which will not be repeated here.

In addition, the wake-up signal in the embodiment of the present disclosure may be a low-power wake-up signal, that is, LP WUS.

In the embodiment of the present disclosure, the network device may receive the beam indication information transmitted by the terminal. The beam indication information is configured to indicate at least one of the optimal beam or the sub-optimal beam. Thus, subsequent uplink and downlink transmission can be ensured.

FIG. 15 is a flowchart of a method for transmitting information according to yet another embodiment. As shown in FIG. 15, the method may be performed by the network device. The method includes a step S1110.

Step S1110 includes transmitting second control information to the terminal.

In an embodiment of the present disclosure, the second control information may include at least one of a correspondence between the monitoring occasion and a paging occasion, or a correspondence between the wake-up signal and the paging occasion. A transmitting beam corresponding to the monitoring occasion is identical to a transmitting beam corresponding to the paging occasion. Alternatively, a transmitting beam corresponding to the wake-up signal is identical to a transmitting beam corresponding to the paging occasion.

It is to be noted that for a plurality of embodiments or features separated by “or,” even if some features are not implementable, other solutions cannot be influenced. In addition, in a case without contradiction, the embodiment of the present disclosure may be combined with another embodiment or implementation and various optional solutions related to the method for the terminal to transmit information, which will not be repeated here.

In addition, the wake-up signal in the embodiment of the present disclosure may be a low-power wake-up signal, that is, LP WUS.

In the embodiment of the present disclosure, the network device may transmit the second control information to the terminal. The second control information may include at least one of the correspondence between the monitoring occasion and the paging occasion, or the correspondence between the wake-up signal and the paging occasion. Thus, the main radio of the terminal can be woken up faster.

FIG. 16 is a block diagram of a terminal 1200 according to an embodiment. With reference to FIG. 16, the terminal 1200 may include a reception module 1210 and a processing module 1220.

The reception module 1210 is configured to receive first control information transmitted by a network device.

The processing module 1220 is configured to determine first duration according to the first control information.

The reception module 1210 is further configured to monitor at least one wake-up signal at at least one monitoring occasion in the first duration.

The processing module 1220 is further configured to determine, according to the at least one wake-up signal, whether to wake up a main radio or whether to change a sleep state of the main radio.

In some implementations, the first duration includes at least one of second duration or third duration. The second duration is related to a LP WUS frame. The third duration is related to a low-power monitoring occasion.

In some implementations, the first control information includes first information. The first information is configured to determine the second duration. The first information includes at least one of a time length of the LP WUS frame, a number of the LP WUS frames in an entire wake-up signal period, a start radio frame of the LP WUS frame, an end radio frame of the LP WUS frame, an identification of the terminal, a density of the LP WUS frames, an offset of the LP WUS frame, or a system frame number of the LP WUS frame.

In some implementations, the first control information further includes second information. The second information is configured to determine the third duration. The second information includes at least one of a time length of the low-power monitoring occasion, a number of the low-power monitoring occasions in an entire wake-up signal period, a start symbol of the low-power monitoring occasion, an end symbol of the low-power monitoring occasion, an identification of the terminal, a number of the LP WUS frames in the entire wake-up signal period, a number of the low-power monitoring occasions in the LP WUS frame, a density of the low-power monitoring occasions, or an index of the low-power monitoring occasion.

In some implementations, the processing module 1220 determines at least one of the following information:
a total number of wake-up signals in the first duration; or
a number of current wake-up signals in the first duration.

In some implementations, the processing module 1220 determines a last wake-up signal in the first duration according to a signal label.

In some implementations, the terminal 1200 further includes:
a transmission module configured to transmit beam indication information to the network device in a case where the terminal determines that the wake-up signal is received.

Alternatively, in a case where the processing module 1220 determines that the reception module receives a last wake-up signal transmitted by the network device in the first duration, the transmission module transmits the beam indication information to the network device.

Alternatively, the transmission module transmits the beam indication information to the network device in feedback time.

The beam indication information is configured to indicate at least one of an optimal beam or a sub-optimal beam.

In some implementations, the reception module 1210 may be further configured to receive second control information transmitted by the network device. The second control information includes at least one of a correspondence between the monitoring occasion and a paging occasion or a correspondence between the wake-up signal and the paging occasion.

In some implementations, a transmitting beam corresponding to the monitoring occasion is identical to a transmitting beam corresponding to the paging occasion, and/or a transmitting beam corresponding to the wake-up signal is identical to a transmitting beam corresponding to the paging occasion.

In some implementations, the terminal includes a low-power wake-up receiver. The processing module 1220 may be further configured to activate the low-power wake-up receiver before specified duration.

According to the embodiments of the present disclosure, the first duration is determined according to the first control information transmitted by the network device, and the at least one wake-up signal is monitored at the at least one monitoring occasion in the first duration, such that the wake-up signal can be positioned more accurately, and further power in a data transmission process can be reduced.

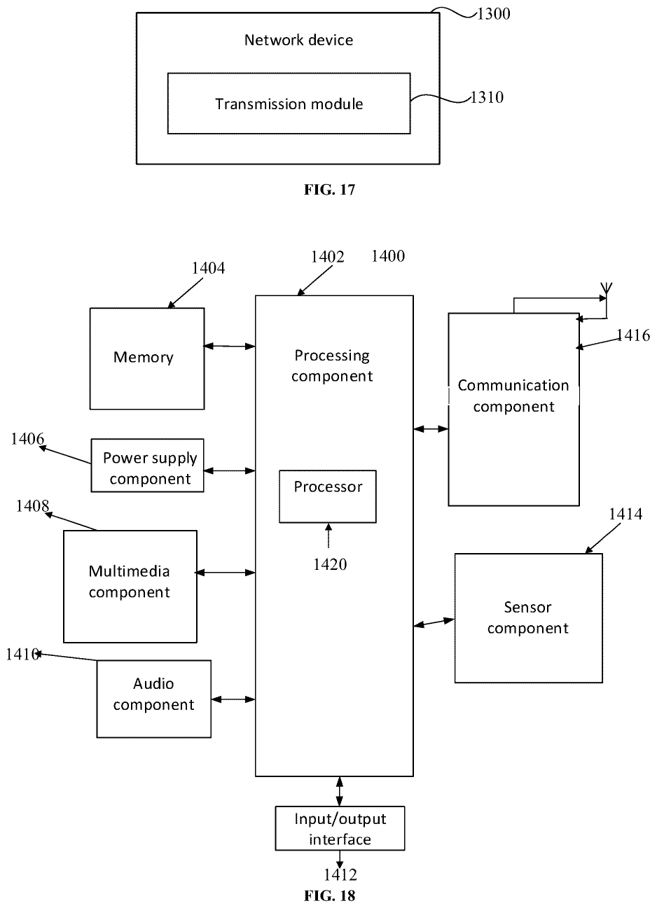

FIG. 17 is a block diagram of a network device 1300 according to an embodiment. With reference to FIG. 17, the network device 1300 may include a transmission module 1310.

The transmission module 1310 is configured to transmit first control information to a terminal. The first control information is configured to determine first duration. The transmission module is further configured to transmit at least one wake-up signal at at least one monitoring occasion in the first duration. The wake-up signal is configured to wake up a main radio or to change a sleep state of the main radio.

In some implementations, the first duration includes at least one of second duration or third duration. The second duration is related to a LP WUS frame. The third duration is related to a low-power monitoring occasion.

In some implementations, the first control information includes first information. The first information is configured to determine the second duration. The first information includes at least one of a time length of the LP WUS frame, a number of the LP WUS frames in an entire wake-up signal period, a start radio frame of the LP WUS frame, an end radio frame of the LP WUS frame, an identification of the terminal, a density of the LP WUS frames, an offset of the LP WUS frame, or a system frame number of the LP WUS frame.

In some implementations, the first control information further includes second information. The second information is configured to determine the third duration. The second information includes at least one of a time length of the low-power monitoring occasion, a number of the low-power monitoring occasions in an entire wake-up signal period, a start symbol of the low-power monitoring occasion, an end symbol of the low-power monitoring occasion, an identification of the terminal, a number of the LP WUS frames in the entire wake-up signal period, a number of the low-power monitoring occasions in the LP WUS frame, a density of the low-power monitoring occasions, or an index of the low-power monitoring occasion.

In some implementations, the network device 1300 may further include:
a reception module configured to receive beam indication information transmitted by the terminal, where the beam indication information is configured to indicate at least one of an optimal beam or a sub-optimal beam; and
a processing module configured to transmit subsequent downlink information based on at least one transmitting beam fed back by the beam indication information.

In some implementations, the transmission module 1310 is further configured to transmit second control information to the terminal. The second control information includes at least one of a correspondence between the monitoring occasion and a paging occasion, or a correspondence between the wake-up signal and the paging occasion.

In some implementations, a transmitting beam corresponding to the monitoring occasion is identical to a transmitting beam corresponding to the paging occasion, and/or, a transmitting beam corresponding to the wake-up signal is identical to a transmitting beam corresponding to the paging occasion.

In the embodiment of the present disclosure, the transmission module 1310 may transmit the first control information to the terminal. The first control information is configured to determine the first duration. The processing module may instruct, through the first control information, the terminal to determine the first duration. In addition, the network device may transmit the at least one wake-up signal at the at least one monitoring occasion in the first duration. In this way, the wake-up signal can be positioned more accurately, and further power in a data transmission process can be reduced.

For the device in the embodiments, a manner for each module to execute an operation is described in detail in the embodiments relating to the method, and will not be described in detail here.

The present disclosure further provides a computer-readable storage medium. The computer-readable storage medium stores computer program instructions. The computer program instructions, when being executed by a processor, implement steps of the method for monitoring a wake-up signal and the method for transmitting information according to the present disclosure.

The present disclosure further provides a communication system. The communication system may include a terminal and a network device. The terminal may perform steps of the method for monitoring a wake-up signal, involving the terminal, in the embodiment. In addition, the network device may perform steps of the method for transmitting information, involving the network device, in the embodiment.

FIG. 18 is a block diagram of a communication device 1400 according to an embodiment. The communication device 1400 may be a terminal. For instance, the communication device 1400 may be a mobile phone, a computer, a digital broadcast terminal, a messaging device, a game console, a tablet device, a medical device, a fitness device, a personal digital assistant, an intelligent vehicle, etc.

With reference to FIG. 18, the communication device 1400 may include one or more of the following components: a processing component 1402, a memory 1404, a power supply component 1406, a multimedia component 1408, an audio component 1410, an input/output interface 1412, a sensor component 1414, and a communication component 1416.

The processing component 1402 generally controls all operations of the communication device 1400, such as operations associated with display, telephone call, data communication, camera operation, and recording operation. The processing component 1402 may include one or more processors 1420 configured to execute instructions, so as to complete all or some steps of the method for monitoring a wake-up signal. In addition, the processing component 1402 may include one or more modules to facilitate interaction between the processing component 1402 and other components. For instance, the processing component 1402 may include a multimedia module to facilitate interaction between the multimedia component 1408 and the processing component 1402.

The memory 1404 is configured to store various types of data, so as to support the operations on the communication device 1400. Instances of the data include instructions used for any application or method operating on the communication device 1400, contact data, phone book data, a message, a picture, a video, etc. The memory 1404 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The power supply component 1406 supplies power to various components of the communication device 1400. The power supply component 1406 may include a power management system, one or more power supplies, and other components associated with generating, managing and distributing power for the communication device 1400.

The multimedia component 1408 includes a screen that provides an output interface between the communication device 1400 and a user. In an embodiment, the screen may include a liquid crystal display (LCD) and a touch panel (TP). In a case where the screen includes the touch panel, the screen may be implemented as a touch screen to receive an input signal from the user. The touch panel includes one or more touch sensors to sense touch, slide and gestures on the touch panel. The touch sensor may sense a boundary of a touch or slide operation, and detect duration and pressure related to the touch or slide operation. In an embodiment, the multimedia component 1408 includes at least one of a front-facing camera or a rear-facing camera. When the communication device 1400 is in an operation mode, such as a photographing mode or a video mode, at least one of the front-facing camera or the rear-facing camera may receive external multimedia data. Each of the front-facing camera and the rear-facing camera may be a fixed optical lens system or have a focal length and an optical zoom capability.

The audio component 1410 is configured to output and/or input an audio signal. For instance, the audio component 1410 includes a microphone (MIC). The microphone is configured to receive an external audio signal when the communication device 1400 is in operation modes such as a call mode, a recording mode and a speech identification mode. The received audio signal may be further stored in the memory 1404 or transmitted via the communication component 1416. In an embodiment, the audio component 1410 further includes a speaker configured to output an audio signal.

The input/output interface 1412 provides an interface between the processing assembly 1402 and a peripheral interface module. The peripheral interface module may be a keyboard, a click wheel, a button, etc. The buttons may include, but are not limited to, a home button, a volume button, a start button, and a lock button.

The sensor component 1414 includes one or more sensors configured to provide various aspects of state assessment for the communication device 1400. For instance, the sensor component 1414 may detect an on/off state of the communication device 1400 and relative positioning of the components such as a display and a keypad of the communication device 1400. The sensor component 1414 may further detect position change of the communication device 1400 or a component of the communication device 1400, presence or absence of contact between the user and the communication device 1400, an orientation or acceleration/deceleration of the communication device 1400, and temperature change of the communication device 1400. The sensor component 1414 may include a proximity sensor configured to detect presence of a nearby object without any physical contact. The sensor component 1414 may further include an optical sensor, such as a complementary metal-oxide-semiconductor (CMOS) or charge-coupled device (CCD) image sensor, which is used in an imaging application. In an embodiment, the sensor component 1414 may further include an acceleration sensor, a gyroscope sensor, a magnetic sensor, a pressure sensor, or a temperature sensor.

The communication component 1416 is configured to facilitate wired or wireless communication between the communication device 1400 and other devices. The communication device 1400 may access a radio network based on a communication standard, such as WiFi, the 2nd generation mobile communication technology (2G) or the 3rd generation mobile communication technology (3G), or their combinations. In one example, the communication component 1416 receives a broadcast signal or broadcast related information from an external broadcast management system via a broadcast channel. In one example, the communication component 1416 further includes a near field communication (NFC) module to facilitate short-range communication. For instance, the NFC module may be implemented on the basis of a radio frequency identification (RFID) technology, an infrared data association (IrDA) technology, an ultra-wideband (UWB) technology, a Bluetooth (BT) technology or other technologies.

In an example, the communication device 1400 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic elements, thus performing the method for monitoring a wake-up signal.

An example further provides a non-transitory computer-readable storage medium including instructions, such as the memory 1404 including instructions. The instructions may be executed by the processor 1420 of the communication device 1400 so as to complete the method for monitoring a wake-up signal. For instance, the non-transitory computer-readable storage medium may be an ROM, a random access memory (RAM), a compact disc-read only memory (CD-ROM), a magnetic tape, a floppy disk, an optical data storage device, etc.

The communication device may be a separate electronic device or part of a separate electronic device. For instance, in an embodiment, the communication device may be an integrated circuit (IC) or a chip, where the integrated circuit may be an IC or a collection of a plurality of ICs. The chip may include, but is not limited to, the following types: a graphics processing unit (GPU), a central processing unit (CPU), FPGA, DSP, ASIC, a system on chip (SoC), etc. The integrated circuit or chip may be configured to execute the executable instructions (or codes), so as to implement the method for monitoring a wake-up signal. The executable instructions may be stored in the integrated circuit or chip, or may be obtained from other apparatuses or devices. For instance, the integrated circuit or chip includes a processor, a memory, and an interface for communication with other apparatuses. The executable instructions may be stored in the memory. The executable instructions, when being executed by the processor, implement the method for monitoring a wake-up signal. Alternatively, the integrated circuit or chip may receive the executable instructions through the interface and transmit the instructions to the processor for execution, so as to implement the method for monitoring a wake-up signal.

Another example further provides a computer program product. The computer program product includes a computer program executable by a programmable device. The computer program has a code part for performing the method for monitoring a wake-up signal when being executed by the programmable device.

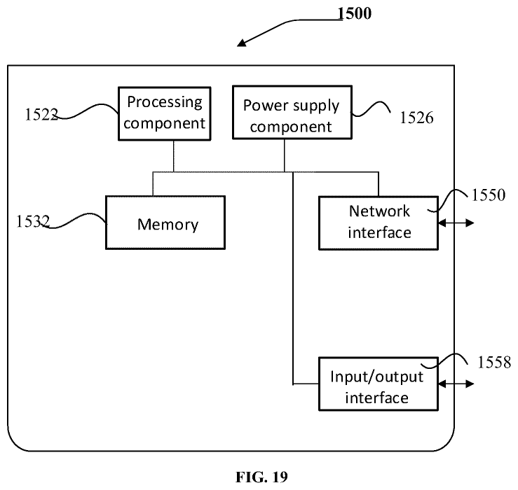

FIG. 19 is a block diagram of a communication device 1500 according to an example. The communication device 1500 may be a network device. For instance, the communication device 1500 may be provided as a server. With reference to FIG. 19, the communication device 1500 includes: a processing component 1522, which further includes one or more processors; and a memory resource represented by a memory 1532. The memory resource is configured to store instructions executable by the processing component 1522, such as an application. The application stored in the memory 1532 may include one or more modules that each correspond to a group of instructions. In addition, the processing component 1522 is configured to execute the instructions, so as to perform the method for transmitting information.

The communication device 1500 may further include a power supply component 1526 configured to perform power management of the communication device 1500, a wired or wireless network interface 1550 configured to connect the communication device 1500 to a network, and an input/output interface 1558. The communication device 1500 may operate an operating system stored in the memory 1532, such as Windows Server™, Mac OS X™, Unix™, Linux™, and FreeBSD™. Those skilled in the art could easily conceive of other implementation solutions of the present disclosure upon consideration of the description and practice of the present disclosure. The present disclosure is intended to cover any variations, uses or adaptive changes of the present disclosure, which follow the general principles of the present disclosure and include common general knowledge or conventional technical means, which is not disclosed in the present disclosure in the art. The description and the embodiments are regarded as merely illustrative, and the true scope and spirit of the present disclosure are indicated by the following claims.

It is to be understood that the present disclosure is not limited to a precise structure described above and illustrated in the accompanying drawings, and can be subjected to various modifications and changes without departing from the scope. The scope of the present disclosure is limited merely by the appended claims.

1. A method for monitoring a wake-up signal, performed by a terminal, the method comprising:
receiving first control information transmitted by a network device;
determining first duration according to the first control information;
monitoring at least one wake-up signal at at least one monitoring occasion in the first duration; and
determining, according to the at least one wake-up signal, whether to wake up a main radio or whether to change a sleep state of the main radio.

2. The method according to claim 1, wherein the first duration comprises at least one of second duration or third duration, wherein the second duration is related to a low-power wake-up signal (LP WUS) frame, and the third duration is related to a low-power monitoring occasion.

3. The method according to claim 2, wherein the first control information comprises first information, the first information is configured to determine the second duration, and the first information comprises at least one of a time length of the LP WUS frame, a number of the LP WUS frames in an entire wake-up signal period, a start radio frame of the LP WUS frame, an end radio frame of the LP WUS frame, an identification of the terminal, a density of the LP WUS frames, an offset of the LP WUS frame, or a system frame number of the LP WUS frame.

4. The method according to claim 2, wherein the first control information further comprises second information, the second information is configured to determine the third duration, and the second information comprises at least one of a time length of the low-power monitoring occasion, a number of the low-power monitoring occasions in an entire wake-up signal period, a start symbol of the low-power monitoring occasion, an end symbol of the low-power monitoring occasion, an identification of the terminal, a number of the LP WUS frames in the entire wake-up signal period, a number of the low-power monitoring occasions in the LP WUS frame, a density of the low-power monitoring occasions, or an index of the low-power monitoring occasion.

5. The method according to any one of claims 1 to 4, wherein the method further comprises:
determining, by the terminal, at least one of:
a total number of the wake-up signals in the first duration; or
a number of current wake-up signals in the first duration.

6. The method according to any one of claims 1 to 4, wherein the method further comprises:
determining a last wake-up signal in the first duration by the terminal according to a signal label.

7. The method according to any one of claims 1 to 4, wherein the method further comprises at least one of:
determining by the terminal that the wake-up signal is received by the terminal, and
transmitting beam indication information to the network device by the terminal;
determining by the terminal that a last wake-up signal transmitted by the network device is received in the first duration by the terminal, and transmitting beam indication information to the network device by the terminal; or
transmitting beam indication information to the network device in feedback time by the terminal;
wherein the beam indication information is configured to indicate at least one of an optimal beam or a sub-optimal beam.

8. The method according to any one of claims 1 to 4, wherein the method further comprises:
receiving second control information transmitted by the network device, wherein the second control information comprises at least one of a correspondence between the monitoring occasion and a paging occasion, or a correspondence between the wake-up signal and the paging occasion.

9. The method according to claim 8, wherein a transmitting beam corresponding to the monitoring occasion is identical to a transmitting beam corresponding to the paging occasion, and/or a transmitting beam corresponding to the wake-up signal is identical to a transmitting beam corresponding to the paging occasion.

10. The method according to any one of claims 1 to 4, wherein the terminal comprises a low-power wake-up receiver, and the method further comprises:
activating the low-power wake-up receiver before specified duration.

11. A method for transmitting information, performed by a network device, the method comprising:
transmitting first control information to a terminal, wherein the first control information is configured to determine first duration; and
transmitting at least one wake-up signal at at least one monitoring occasion in the first duration, wherein the wake-up signal is configured to wake up a main radio or to change a sleep state of the main radio.

12. The method according to claim 11, wherein the first duration comprises at least one of second duration or third duration, wherein the second duration is related to a low-power wake-up signal (LP WUS) frame, and the third duration is related to a low-power monitoring occasion.

13. The method according to claim 12, wherein the first control information comprises first information, the first information is configured to determine the second duration, and the first information comprises at least one of a time length of the LP WUS frame, a number of the LP WUS frames in an entire wake-up signal period, a start radio frame of the LP WUS frame, an end radio frame of the LP WUS frame, an identification of the terminal, a density of the LP WUS frames, an offset of the LP WUS frame, or a system frame number of the LP WUS frame.

14. The method according to claim 12, wherein the first control information further comprises second information, the second information is configured to determine the third duration, and the second information comprises at least one of a time length of the low-power monitoring occasion, a number of the low-power monitoring occasions in an entire wake-up signal period, a start symbol of the low-power monitoring occasion, an end symbol of the low-power monitoring occasion, an identification of the terminal, a number of the LP WUS frames in the entire wake-up signal period, a number of the low-power monitoring occasions in the LP WUS frame, a density of the low-power monitoring occasions, or an index of the low-power monitoring occasion.

15. The method according to any one of claims 11 to 14, wherein the method further comprises:
receiving beam indication information transmitted by the terminal, wherein the beam indication information is configured to indicate at least one of an optimal beam or a sub-optimal beam; and
transmitting subsequent downlink information based on at least one transmitting beam fed back by the beam indication information.

16. The method according to any one of claims 11 to 14, wherein the method further comprises:
transmitting second control information to the terminal, wherein the second control information comprises at least one of a correspondence between the monitoring occasion and a paging occasion, or a correspondence between the wake-up signal and the paging occasion.

17. The method according to claim 16, wherein a transmitting beam corresponding to the monitoring occasion is identical to a transmitting beam corresponding to the paging occasion, and/or a transmitting beam corresponding to the wake-up signal is identical to a transmitting beam corresponding to the paging occasion.

18. A terminal, comprising:
a reception module configured to receive first control information transmitted by a network device; and
a processing module configured to determine first duration according to the first control information;
wherein the reception module is further configured to monitor at least one wake-up signal at at least one monitoring occasion in the first duration; and
the processing module is further configured to determine, according to the at least one wake-up signal, whether to wake up a main radio or whether to change a sleep state of the main radio.

19. A network device, comprising:
a transmission module configured to transmit first control information to a terminal, wherein the first control information is configured to determine first duration; and
the transmission module is further configured to transmit at least one wake-up signal at at least one monitoring occasion in the first duration, and the wake-up signal is configured to wake up a main radio or to change a sleep state of the main radio.

20. A communication device, comprising:
a processor; and
a memory configured to store processor-executable instructions;
wherein the processor, when executing the processor-executable instructions, is configured to implement the method according to any one of claims 1 to 10.

21. A communication device, comprising:
a processor; and
a memory configured to store processor-executable instructions;
wherein the processor, when executing the processor-executable instructions, is configured to implement the method according to any one of claims 11 to 17.

22. A communication system, comprising the terminal according to claim 20 and the network device according to claim 21.

23. A computer-readable storage medium, storing computer program instructions, wherein the computer program instructions, when executed by a processor, implement the method according to any one of claims 1-17.
